(19) United States
(12) Patent Application Publication
(10) Pub. No.: US 2015/0271360 A1
(43) Pub. Date: Sep. 24, 2015

(54) IMAGE PROCESSING APPARATUS, IMAGE PROCESSING METHOD, AND NON-TRANSITORY COMPUTER READABLE MEDIUM

(71) Applicant: FUJI XEROX CO., LTD., Tokyo (JP)

(72) Inventors: Minoru SODEURA, Kanagawa (JP); Shigeru OKADA, Kanagawa (JP); Katsuya KOYANAGI, Kanagawa (JP); Shinji HANAOKA, Kanagawa (JP); Shintaro ADACHI, Kanagawa (JP); Hiroyuki KISHIMOTO, Kanagawa (JP)

(73) Assignee: FUJI XEROX CO., LTD., Tokyo (JP)

(21) Appl. No.: 14/552,658

(22) Filed: Nov. 25, 2014

(30) Foreign Application Priority Data
Mar. 18, 2014 (JP) 2014-055001

(51) Int. Cl. H04N 1/387; H04N 19/156; H04N 19/103

(52) U.S. Cl. CPC H04N 1/3871; H04N 19/103; H04N 19/156

(57) ABSTRACT

An image processing apparatus includes a generating unit that generates combined image data by size-reducing and arranging document read images having plural pages in accordance with a specified number of pages, a deciding unit that decides a compression method for the data, and a compression processing unit that compresses the data by a compression method decided by the deciding unit. During processing for determining a compression method suitable for the contents of each page of the data that is performed on the pages when the compression method for the data is specified, when a determined compression method for a particular page included in the data is an overriding compression method, the deciding unit cancels the processing and does not perform the processing on remaining pages, for each of which a compression method has not been determined, and sets the overriding compression method as the compression method for the data.

### CROSS-REFERENCE TO RELATED APPLICATIONS

This application is based on and claims priority under 35 USC 119 from Japanese Patent Application No. 2014-055001 filed Mar. 18, 2014.

### BACKGROUND

1. (i) Technical Field

The present invention relates to an image processing apparatus, an image processing method, and a non-transitory computer readable medium.

2. (ii) Related Art

In recent years, paper documents have generally been electronically stored by being scanned by a digital multifunction machine or the like and are distributed. In this case, it is desirable that the file size of each document be small.

### SUMMARY

According to an aspect of the invention, there is provided an image processing apparatus including a generating unit that generates a combined image data item by reducing read images of a document that has plural pages and arranging the read images in accordance with a specified number of pages, a deciding unit that decides a compression method for the combined image data item, and a compression processing unit that compresses the combined image data item by a compression method that has been decided by the deciding unit. During processing for determining a compression method suitable for contents of each of the pages, which are included in the combined image data item, that is performed on each of the pages when the compression method for the combined image data item is specified, when a compression method that has been determined for a particular page, which is included in the combined image data item, is an overriding compression method that has the highest priority over any other compression methods, the deciding unit cancels the processing for determining a compression method so as not to perform the processing on remaining pages, for each of which a compression method has not been determined, and sets the overriding compression method as the compression method for the combined image data item.

### BRIEF DESCRIPTION OF THE DRAWINGS

An exemplary embodiment of the present invention will be described in detail based on the following figures, wherein:

FIG. 1 is a block schematic diagram of an image forming apparatus, which is an image processing apparatus according to the exemplary embodiment of the present invention;

FIG. 2 is a hardware configuration diagram of the image forming apparatus of the exemplary embodiment;

FIG. 3 is a flowchart illustrating a compression method deciding process of the exemplary embodiment;

FIG. 4A is a conceptual diagram illustrating page images that have not been compressed at the time of determining a compression method and a page image that is obtained after compressing the page images in the exemplary embodiment; and

FIG. 4B is another conceptual diagram illustrating page images that have not been compressed at the time of determining a compression method and a page image that is obtained after compressing the page images in the exemplary embodiment.

### DETAILED DESCRIPTION

An exemplary embodiment of the present invention will be described below with reference to the drawings.

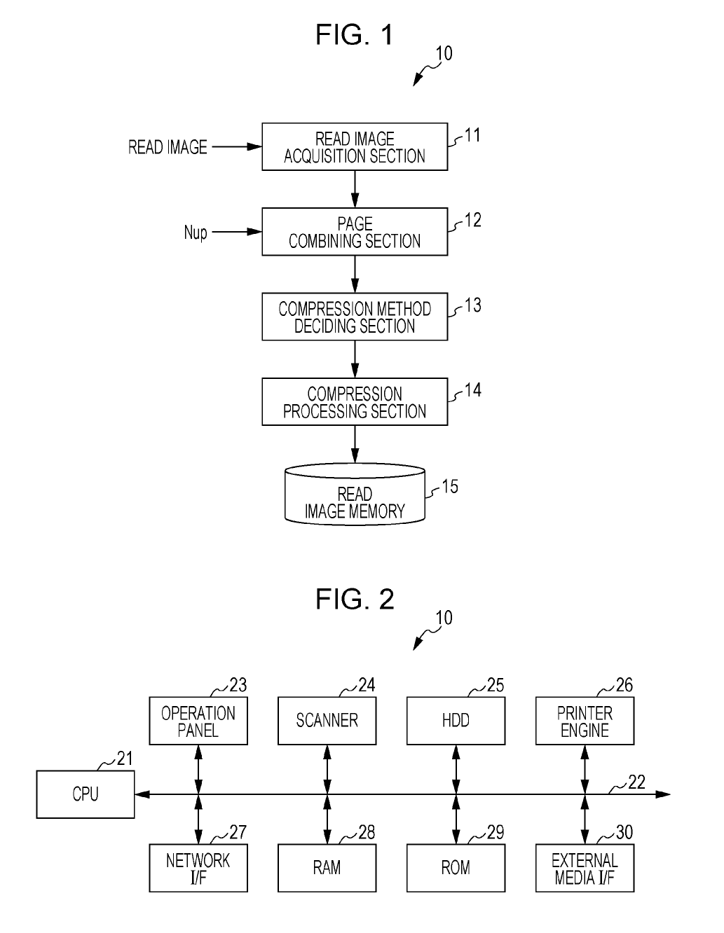

FIG. 1 is a block schematic diagram of an image forming apparatus 10, which is an image processing apparatus according to the exemplary embodiment of the present invention. FIG. 2 is a hardware configuration diagram of the image forming apparatus 10 of the exemplary embodiment. The image forming apparatus 10 is a multifunction machine that is provided with various functions such as a scanner function, a copy function, and an N-up function and is an apparatus with a built-in computer. In FIG. 2, a CPU 21 controls the operations of various devices such as a scanner 24 and a printer engine 26, which are mounted in the image forming apparatus 10, in accordance with programs stored in a ROM 29. An address data bus 22 is connected to the various devices, which are configured to be controlled by the CPU 21, and performs data communication with the various devices. An operation panel 23 receives an instruction from a user and performs display of information. The scanner 24 reads a document that has been set by a user and stores the document as electronic data in a hard disk drive (HDD) 25 or the like. An electronic document, which is read by the scanner 24, and the like are stored in the HDD 25. A confidential box that is used in the present exemplary embodiment is provided in the HDD 25. The printer engine 26 prints an image on an output sheet in accordance with an instruction from a control program that is executed by the CPU 21. A network interface (I/F) 27 connects the image forming apparatus 10 to a network and is used to transmit electronic data, which has been generated by the image forming apparatus 10, receive electronic mail, which is transmitted to the image forming apparatus 10, access the image forming apparatus 10 through a browser, and the like. A RAM 28 is configured to be used as a work memory at the time of executing a program or as a communication buffer for transmitting and receiving electronic data. Various programs that relate to control of the image forming apparatus 10, electronic data encryption, and transmission and reception of electronic data are stored in the ROM 29. As a result of the various programs being executed, each component, which will be described later, may realize a certain processing capability. An external media interface (I/F) 30 is an interface between the image forming apparatus 10 and an external memory device such as a universal serial bus (USB) memory or a flash memory.

The N-up function may sometimes be prepared as an option for the scanner function and the copy function. The N-up function in the present exemplary embodiment refers to functions of, in the case of using the scanner function, dividing read images, which are generated by scanning a document that has plural pages, into blocks for every N pages and forming one image by combining the read images of N pages included in each block. In the case of using the copy function, the N-up function refers to functions including the above-described functions and also a function of outputting the images, which are formed as a result of using the above-described functions. As described above, the term “N” is the number of pages of images that are to be combined into one image and is generally specified by a user through the operation panel 23. For example, in the case where a document size and an output size are both A4, when 2 is specified as N (i.e., 2-up), the areas of read images of a document having two pages are each reduced by half and combined in such a manner as to form one A4 image. Alternatively, in the case where 4 is specified as N (i.e., 4-up), the areas of read images of a document having four pages are each reduced to one-quarter and combined in such a manner as to form one A4 image. Note that when trying to include all the images that are to be output in one A4 image, the images whose areas have been reduced are rotated as may be necessary.

Returning to FIG. 1, the image forming apparatus 10 of the present exemplary embodiment includes a read image acquisition section 11, a page combining section 12, a compression method deciding section 13, a compression processing section 14, and a read image memory 15. The read image acquisition section 11 acquires read images of a document that is read by the scanner 24. The page combining section 12 reduces, in accordance with a specified number of pages, the areas of the read images of the document having plural pages and arranges the read images in such a manner as to generate combined image data items. Here, the term “specified number of pages” corresponds to “N”, which is to be specified at the time of using the above-described N-up function, and one image (an image having one page) is to be formed for each block. During processing for determining a compression method suitable to compress each of the page images, which are included in such a combined image data item, in accordance with the contents of the page image that is performed on each of the pages when a compression method for the combined image data item is specified, in the case where a compression method that has been determined is an overriding compression method that has the highest priority over any other compression methods, the compression method deciding section 13 cancels the processing for determining a compression method so as not to perform the processing on the remaining pages, for each of which a compression method has not been determined, and sets the overriding compression method as a compression method for the block, which is the combined image data item. The compression processing section 14 is provided as a compression processing unit and generates one image by collectively compressing the images of all the pages that are included in one combined image data item by a compression method that has been specified by the compression method deciding section 13. An image that is formed by the compression processing section 14 is stored in the read image memory 15.

The components in the image forming apparatus 10, which are indicated by reference numerals 11 to 14, are realized by cooperative operations of the computer, which is mounted in the image forming apparatus 10, and programs that are executed by the CPU 21, which is mounted in the computer. In addition, the read image memory 15 is realized by the HDD 25, which is mounted in the image forming apparatus 10. Alternatively, the RAM 28 or an external memory may be used via a network in order to realize the read image memory 15.

The programs that are used in the present exemplary embodiment may be provided by being stored in a computer-readable recording medium such as a USB memory or a compact disc read-only memory (CD-ROM) through the external media I/F 30 as well as being provided by a communication unit. The programs provided by such a communication unit or such a recording medium are installed in the computer, and the CPU 21 of the computer sequentially executes the programs, so that various processing operations are realized.

In the case where one A4 image is formed by, for example, combining images of an A4 document having plural pages by using the N-up function in such a manner that all the images are included in the one A4 image, it is necessary to reduce the areas of the document images by compressing the document images. Here, in the present exemplary embodiment, for convenience of description, the images are compressed by using any one of a high compression method and a small-number-of-colors-compression method. Obviously, any compression method other than these compression methods may be used, and three or more types of compression methods may be employed.

The high compression method is a compression method by which images of a document are divided into regions in accordance with characteristics of the images such as characters, designs, and photographs, and each of the images that have been divided is compressed by using a compression method suitable for the image. In the case of using the high compression method, the appearance of the images will not deteriorate while high compressibility is realized. By using the high compression method, images of a document may be suitably compressed regardless of the type of the document such as a document that includes a color image, a document that includes a character, a document that includes a photograph, or a document that includes both a character and a photograph.

In contrast, the small-number-of-colors-compression method is a dedicated compression method for images of documents that include characters and line drawings and in which only a small number of specific colors such as black, red, and blue are used to express such characters and the like. In the case of using the small-number-of-colors-compression method, compression of text documents with high compressibility may be realized.

Accordingly, in the case where it is determined that, as a result of analyzing a read image of one page of a document, the read image is a document image in which only a small number of colors are used to express a character and a line drawing, the page image is compressed by the small-number-of-colors-compression method. On the other hand, in the case where it is determined that the read image is a photograph image or a document image that includes both a character and a photograph, the page image is compressed by the high compression method.

In the case where the use of the N-up function is specified, a page-combined image is formed by combining images of a document having plural pages, and when the images, which are included in the page-combined image, are compressed, in the present exemplary embodiment, all the pages, which are included in the page-combined image, are collectively compressed by using the same compression method. There may be a case where the page-combined image includes both an image of a document that includes only a character and a line drawing for which the small-number-of-colors-compression method should be applied and an image of a document that includes a photograph image for which the high compression method should be applied. In such a case, considering compression of photograph images, in the case where even one page of the page-combined image is a page having an image of a document that includes a photograph image, it may be decided that the high compression method is employed as a compression method for the page-combined image rather than the small-number-of-colors-compression method. As described above, when a compression method suitable for each page-combined image is decided, it is necessary to determine a compression method for an image of each page included in the page-combined image.

Note that, in the present exemplary embodiment, there is no mention of which one of the high compression method and the small-number-of-colors-compression method is better in terms of compressibility and image quality. Among these methods, the one that has a longer compression time may have an advantage over the other. In the present exemplary embodiment, an example in which the high compression method is a compression method that has a longer compression time than the small-number-of-colors-compression method is described.

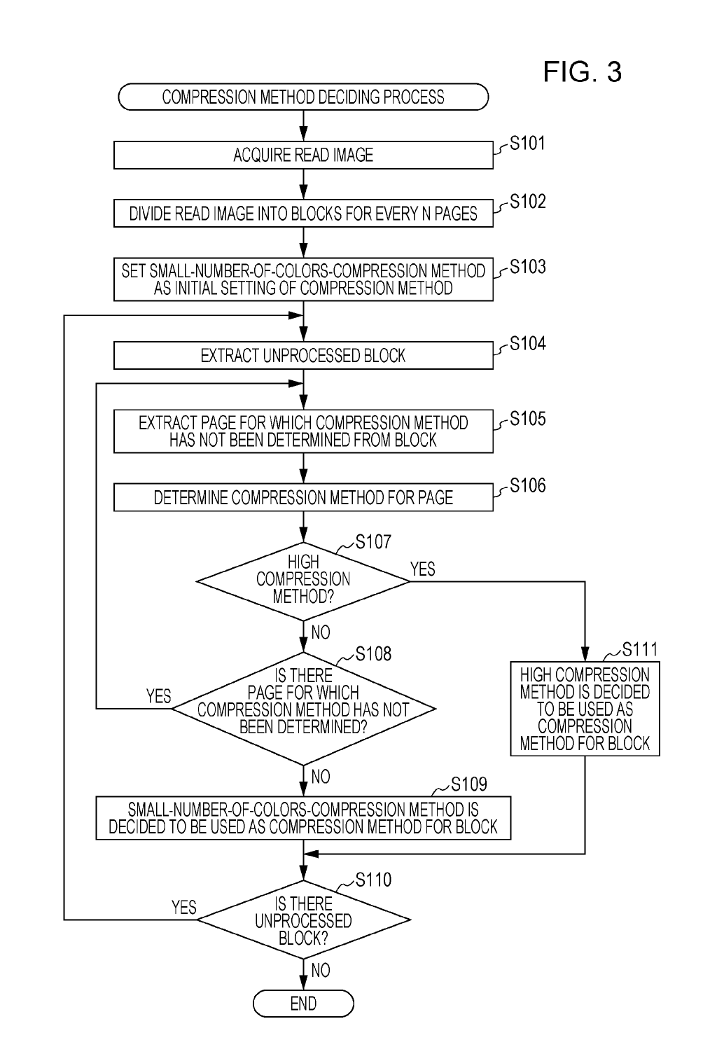

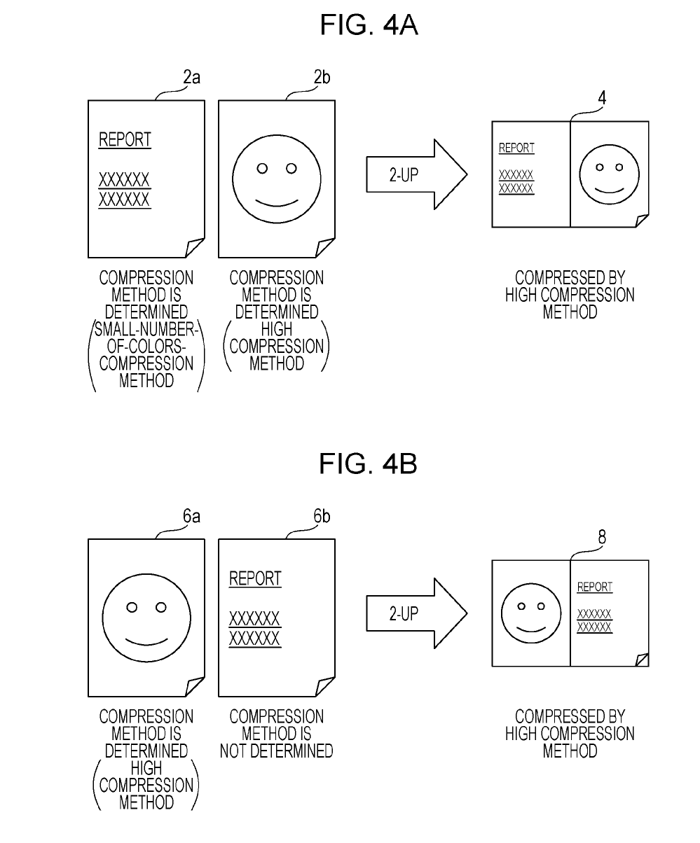

A compression method deciding process in the present exemplary embodiment will now be described with reference to the flowchart illustrated in FIG. 3. Note that, in order to make the following description simple, the case where two pages forming a document are combined into one page, that is, the case of 2-up will be described as an example. In addition, one of the two pages includes characters for which the small-number-of-colors-compression method is suitable (a document 2a and a document 6b respectively illustrated in FIG. 4A and FIG. 4B as examples) and the other one of the two pages includes a photograph for which the high compression method is suitable (a document 2b and a document 6a respectively illustrated in FIG. 4A and FIG. 4B as examples).

A user sets the document, which has the two pages, in a document table or an auto document feeder (ADF) of the scanner 24 and specifies 2-up image formation, and after that, the user issues a scan instruction by pressing a scanner button, which is displayed on the operation panel 23, or the like. Then, the read image acquisition section 11 acquires read images that are generated by reading all the pages by the scanner 24 (step 101), and after that, the page combining section 12 divides the read images for every specified number of pages (N=2) and forms the page-combined image (step 102). In this example, only one page-combined image is formed.

Subsequently, the compression method deciding section 13 sets the small-number-of-colors-compression method as an initial setting of a compression method that is to be applied for the page-combined image (step 103). Then, the compression method deciding section 13 extracts an unprocessed page-combined image for which a compression method has not been set from the page-combined image, which has been formed (step 104). Basically, since page-combined images are formed by combining every two pages of a document starting from the first page, the compression method deciding section 13 performs the extraction process on the page-combined images starting from the page-combined image that includes a page having the smallest page number. However, the steps of the extraction process are not necessarily performed in this order. Subsequently, the compression method deciding section 13 extracts a page for which a compression method has not been determined from the page-combined image, which has been extracted (step 105). Basically, the compression method deciding section 13 performs the extraction process on the pages of the page-combined image starting from the page that has the smallest page number. However, the steps of the extraction process are not necessarily performed in this order.

After the compression method deciding section 13 has determined a page to be processed, the compression method deciding section 13 determines a compression method suitable for compressing the page by analyzing the image of the page (step 106). More specifically, as described above, in the case where it is determined that the image of the page is a document image in which only a small number of colors are used to express a character and a line drawing, the compression method deciding section 13 sets the small-number-of-colors-compression method as a compression method for the page. On the other hand, in the case where it is determined that the image of the page is a document image that includes a photograph and the like rather than the above-mentioned document image, the compression method deciding section 13 sets the high compression method as the compression method for the page. As described above, a technology of the related art may be used for image analysis in which the type of document is determined in accordance with the contents (a character, a photograph, and the like) of an image of a page of the document.

Through the above-described process, in the case where it has been determined that the small-number-of-colors-compression method is to be used as a compression method for the page (N in step 107), the next page for which a compression method has not been determined becomes a process target (Y in step 108), and the above-described process is repeated (step 104 to step 106). Here, in the case where it has been determined that the small-number-of-colors-compression method is to be used as each of the compression methods for all the images included in the page-combined image (N in step 108), the small-number-of-colors-compression method is set to be used as a compression method that is used for collectively compressing all the images included in the page-combined image (step 109).

On the other hand, in the case where the high compression method is set in step 106 (Y in step 107), the high compression method is set to be used as a compression method that is used for collectively compressing all the images included in the page-combined image (step 111). In particular, in the present exemplary embodiment, even if there is a page for which a compression method has not yet been determined when the high compression method has been set in step 106, the high compression method is set as a compression method for the page-combined image, and the compression method deciding section 13 cancels the processing for determining a compression method without performing the processing on the remaining pages, for each of which a compression method has not been determined. The time taken to determine a compression method for the page-combined image is reduced by an amount equal to the time taken to perform the processing, which has been canceled.

The above-described process is repeated and performed on all the page-combined images, which have been formed by dividing a document having plural pages, (Y in step 110), and when compression methods for all the page-combined images have been determined (N in step 110), the compression method deciding section 13 finishes the process.

The above-described process will be described using a specific example.

In FIG. 4A, the document 2a that only includes texts and the document 2b that includes a photograph are illustrated as the first page and the second page of a document, respectively. When images of the document, which includes these two pages, are scanned while the 2-up setting is specified, the first page is an image of a text document, and thus, the small-number-of-colors-compression method is set as a compression method for the first page (step 106). Since the compression method, which has been set, is not the high compression method (N in step 107), the second page becomes a process target (Y in step 108). Since the second page is an image of a document that includes a photograph, the high compression method is set as a compression method for the second page (step 106). Since the compression method, which has been set, is the high compression method (Y in step 107), both the documents 2a and 2b that are to be included in a page-combined image illustrated in FIG. 4A are compressed by the high compression method, and as a result, a read image 4 of the document is formed (step 111).

In FIG. 4B, the document 6a that includes a photograph and the document 6b that only includes texts are illustrated as the first page and the second page of a document, respectively. When images of the document, which includes these two pages, are scanned while the 2-up setting is specified, the first page is an image of a document that includes a photograph, and thus, the high compression method is set as a compression method for the first page (step 106). Since the compression method, which has been set, is the high compression method (Y in step 107), both the documents 6a and 6b that are to be included in a page-combined image illustrated in FIG. 4B are compressed by the high compression method, and as a result, a read image 8 of the document is formed (step 111). As illustrated in FIG. 4B, the processing for determining a compression method will not be performed on the document 6b, which is a page subsequent to the page for which the high compression method has been set as a compression method.

In the case where the first page of a page-combined image that includes images of four pages as a result of specifying the 4-up setting is an image of a document that includes a photograph, the processing for determining a compression method will not be performed on the remaining three pages. In other words, it is not necessary to take time to determine what compression methods are to be used for the three pages. Similarly, in the case where the third page of a page-combined image that includes images of eight pages as a result of specifying an 8-up setting is an image of a document that includes a photograph (the first and second pages are images of documents that only include texts), the processing for determining a compression method will not be performed on the remaining five pages. In other words, it is not necessary to take time to determine what compression methods are to be used for the five pages.

After the compression method for the page-combined image has been determined in the manner described above, the compression processing section 14 collectively compresses the images of the pages included in the page-combined image by the compression method that has been set by the compression method deciding section 13 and forms an image having one page (one image). The image, which has been formed, is stored in the read image memory 15 as an image that has been read by using the N-up function. Obviously, the read image that has been formed by the compression processing section 14 may be stored in a different memory or transmitted to a different device via a network as may be necessary as well as being stored in the read image memory 15.

Note that the processing, which has been described above, may be applied to the copy function, in which all the pages of a document are read beforehand and then copied, as well as the scan function.

In the present exemplary embodiment, for convenience of description, any one of the two types of compression methods, which are the high compression method and the small-number-of-colors-compression method, is used. If a compression method may be selected from three or more types of compression methods, it will be necessary to select any one of the compression methods for each page-combined image. In this case, for example, the priority of each of the compression methods may be set beforehand, and one compression method having the highest priority among the compression methods that are determined for all the pages included in the page-combined image may be employed. Obviously, when an overriding compression method is set to be used as a compression method for a particular page, in a similar manner to the above, the overriding compression method may be set as the compression method for the page-combined image, and the processing for determining a compression method for subsequent pages may be canceled.

Note that, although the case where the image forming apparatus 10 is used as an image processing apparatus has been described as an example in the present exemplary embodiment, the image processing apparatus may be realized by a computer such as a versatile personal computer (PC) that is configured to acquire an image read by a scanner.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus comprising:
a generating unit that generates a combined image data item by reducing read images of a document that has a plurality of pages and arranging the read images in accordance with a specified number of pages;
a deciding unit that decides a compression method for the combined image data item; and
a compression processing unit that compresses the combined image data item by a compression method that has been decided by the deciding unit,
wherein, during processing for determining a compression method suitable for contents of each of the pages, which are included in the combined image data item, that is performed on each of the pages when the compression method for the combined image data item is specified, when a compression method that has been determined for a particular page, which is included in the combined image data item, is an overriding compression method that has the highest priority over any other compression methods, the deciding unit cancels the processing for determining a compression method so as not to perform the processing on remaining pages, for each of which a compression method has not been determined, and sets the overriding compression method as the compression method for the combined image data item.

2. The image processing apparatus according to claim 1,
wherein the overriding compression method is a compression method in which the read images of the document are divided into regions in accordance with characteristics of the read images such as a character, a design, and a photograph, and each of the read images that have been divided is compressed by a compression method suitable for the read image.

3. An image processing method comprising:
generating a combined image data item by reducing read images of a document that has a plurality of pages and arranging the read images in accordance with a specified number of pages;
deciding a compression method for the combined image data item; and
compressing the combined image data item by a compression method that has been decided by the deciding unit,
wherein, during processing for determining a compression method suitable for contents of each of the pages, which are included in the combined image data item, that is performed on each of the pages when the compression method for the combined image data item is specified, when a compression method that has been determined for a particular page, which is included in the combined image data item, is an overriding compression method that has the highest priority over any other compression methods, the processing for determining a compression method is canceled and not performed on remaining pages, for each of which a compression method has not been determined, and the overriding compression method is set as the compression method for the combined image data item.

4. A non-transitory computer readable medium storing a program causing a computer to perform a process, the process comprising:
generating a combined image data item by reducing read images of a document that has a plurality of pages and arranging the read images in accordance with a specified number of pages;
deciding a compression method for the combined image data item; and
compressing the combined image data item by a compression method that has been decided by the deciding unit,
wherein, during processing for determining a compression method suitable for contents of each of the pages, which are included in the combined image data item, that is performed on each of the pages when the compression method for the combined image data item is specified, when a compression method that has been determined for a particular page, which is included in the combined image data item, is an overriding compression method that has the highest priority over any other compression methods, the processing for determining a compression method is canceled and not performed on remaining pages, for each of which a compression method has not been determined, and the overriding compression method is set as the compression method for the combined image data item.
